(19) United States
(12) Patent Application Publication
(10) Pub. No.: US 2024/0373536 A1
(43) Pub. Date: Nov. 7, 2024

(54) LIGHTNING DISCHARGE INDUCTION SYSTEM, LIGHTNING DISCHARGE INDUCTION AIRCRAFT, VOLTAGE CONTROL DEVICE

(71) Applicant: Nippon Telegraph and Telephone Corporation, Tokyo (JP)

(72) Inventors: Toshihisa MASUDA, Musashino-shi, Tokyo (JP); Masato MARUYAMA, Musashino-shi, Tokyo (JP); Nobue AOKI, Musashino-shi, Tokyo (JP); Fumihiko ISHIYAMA, Musashino-shi, Tokyo (JP); Naruto ARAI, Musashino-shi, Tokyo (JP); Jun KATO, Musashino-shi, Tokyo (JP)

(21) Appl. No.: 18/562,890

(22) PCT Filed: Jun. 1, 2021
(86) PCT No.: PCT/JP2021/020847

§ 371 Date: Nov. 21, 2023

(51) Int. Cl. H05F 3/04; B64D 45/02; H01T 19/04; H05F 3/02

(52) U.S. Cl. CPC H05F 3/04; B64D 45/02; H01T 19/04; H05F 3/02

(57) ABSTRACT

This lightning discharge induction system includes a flying object (1) flying in the air, a discharge electrode (11) provided to the flying object, a ground electrode (3) provided on the ground, an electric wire (2) connecting the discharge electrode (11) and the ground electrode (11), and a voltage control device (4) controlling a voltage generated in the discharge electrode (11). The voltage control device (4) includes a pulse power supply (41) for generating a pulse voltage, and a trigger switch (S1). By turning on the trigger switch (S1), a pulse voltage is supplied to the discharge electrode (11), a dielectric breakdown is caused between a thundercloud (50) and the discharge electrode (11), and the thundercloud (50) induces a lightning discharge

### TECHNICAL FIELD

The present invention relates to a lightning discharge induction system, a lightning discharge induction flying object, and a voltage control device.

### BACKGROUND ART

The technique disclosed in NPL 1 is known as a method of preventing accidents caused by lightning strikes. NPL 1 discloses a technique for preventing lightning strike from occurring at an unspecified place by connecting a grounded electric wire to a flying body such as a drone, flying the flying body into an area where thunderclouds are generated, and discharging electric charges accumulated in the thunderclouds into the flying object.

### CITATION LIST

### Non Patent Literature

[NPL 1] “Lightning Control and Charging Technology” NTT R&D Forum 2020

### SUMMARY OF INVENTION

### Technical Problem

However, the technique disclosed in NPL 1 is configured to induce lightning discharges by flying an unmanned flying object close to a thundercloud to generate a dielectric breakdown between the thundercloud and the flying object. The timing at which a dielectric breakdown occurs is greatly affected by the state of the atmosphere such as the amount of electric charges accumulated in the thundercloud, the speed of accumulation of the electric charges, the wind velocity, and the like.

Therefore, a dielectric breakdown cannot be generated at the timing intended by the user, and the time required to keep the flying object in the air was long, making it impossible to generate dielectric breakdowns efficiently and trigger lightning discharges.

The present invention has been made in view of the above-mentioned circumstances, and an object of the present invention is to provide a lightning discharge induction system and a lightning discharge induction flying object capable of inducing a lightning discharge at a timing intended by a user, and a voltage control device.

### Solution to Problem

A lightning discharge induction system according to an embodiment of the present invention includes a flying object flying in the air, a conductor provided to the flying object, a ground electrode provided on the ground, an electric wire connecting the conductor and the ground electrode, and a voltage control device for controlling a voltage generated in the conductor.

A lightning discharge induction flying object according to an embodiment of the present invention is a lightning discharge induction flying object flying in the air to induce a lightning discharge, the lightning discharge induction flying object comprising a conductor, and an electric wire connecting the conductor and a ground electrode provided on the ground.

A voltage control device according to an embodiment of the present invention is a voltage control device that generates a voltage for inducing a lightning discharge in a conductor provided to a flying object, the voltage control device including a power supply unit that generates a pulse voltage, and a trigger switch that performs an operation of outputting the pulse voltage to an electric wire connecting the conductor and a ground electrode provided on the ground.

### Advantageous Effects of Invention

According to the present invention, a lightning discharge can be induced at a timing intended by a user.

### BRIEF DESCRIPTION OF DRAWINGS

FIG. 1 is a schematic configuration diagram of a lightning discharge induction system according to an embodiment.

FIG. 2 is an explanatory diagram showing the relationship between electric charge accumulated in a thundercloud and a flying object.

FIG. 3 is an equivalent circuit diagram of the lightning discharge induction system according to the embodiment.

FIG. 4 is an equivalent circuit diagram of a lightning discharge induction system according to a first modification.

FIG. 5 is an equivalent circuit diagram of a lightning discharge induction system according to a second modification.

### DESCRIPTION OF EMBODIMENTS

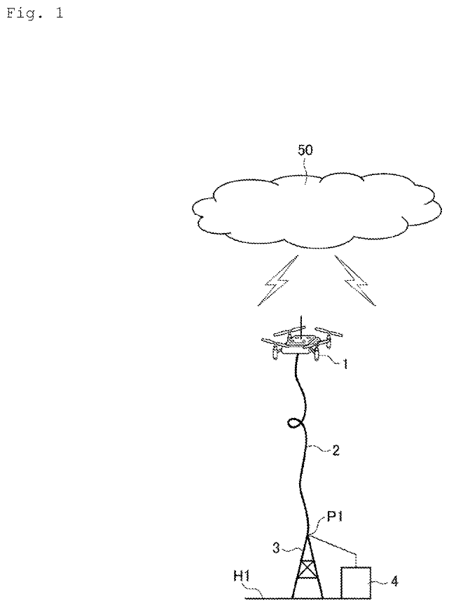

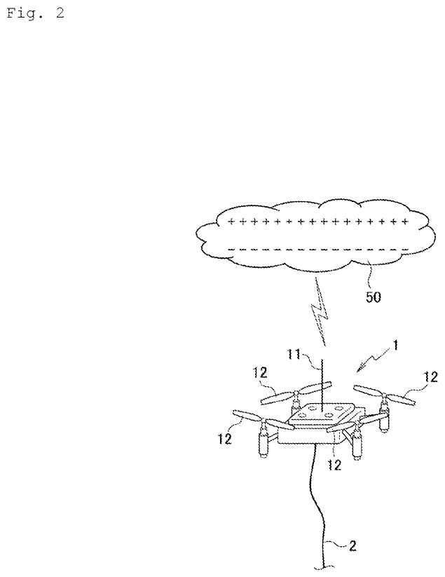

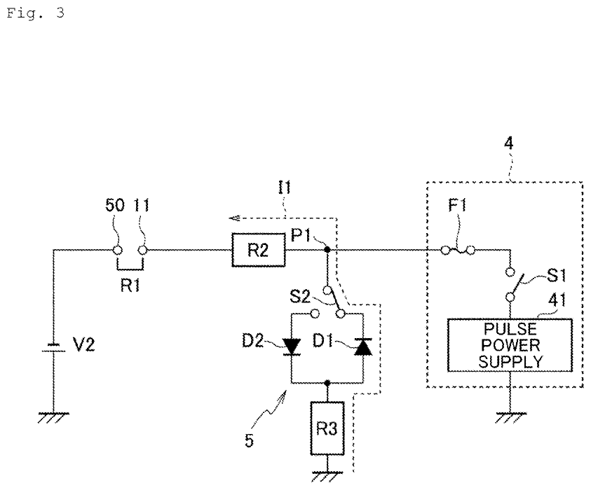

Hereinafter, embodiments of the present invention will be described with reference to the drawings. FIG. 1 is a schematic configuration diagram of a lightning discharge induction system according to an embodiment. FIG. 2 is an explanatory diagram showing the relationship between electric charge accumulated in a thundercloud 50 and a flying object 1. FIG. 3 is an equivalent circuit diagram of the lightning discharge induction system according to the present embodiment.

As shown in FIG. 1, a lightning discharge induction system according to an embodiment includes the flying object 1 (lightning discharge induction flying object), an electric wire 2, a ground electrode 3, and a voltage control device 4.

The flying object 1 is capable of moving unmanned in the sky by remote control by a user. As shown in FIG. 2, a propeller 12 is provided to the flying object 1. The flying object 1 can move to an arbitrary position and an arbitrary altitude by driving each propeller 12 by autopilot or manual remote control. The flying object 1 itself may be provided with a lightning countermeasure mechanism such as a Faraday cage and a discharge electrode 11 (conductor). Since the autopilot and remote control of the flying object 1 are well known techniques, detailed explanations thereof are omitted. A drone, a balloon, an unmanned helicopter or the like can be used as the flying object 1 that flies unmanned.

One end of the electric wire 2 is connected to the discharge electrode 11 provided to the flying object 1, and the other end is connected to the ground electrode 3. The electric wire 2 electrically connects the discharge electrode 11 and the ground electrode 3.

A covered wire, a bare wire, a cable, a stranded wire, and the like can be used as the electric wire 2. The electric wire 2 has a length capable of connecting the flying object 1 and the ground electrode 3 when the flying object 1 approaches the thundercloud 50 existing in the sky. The electric wire 2 has a length of, for example, several hundred meters. The electric wire 2 may have a length exceeding 1 km.

The electric wire 2 is preferably of a thickness and material with a resistance value that does not generate excessive heat when a dielectric breakdown occurs between the discharge electrode 11 and the thundercloud 50 and a current due to a lightning discharge flows.

The ground electrode 3 is provided on the ground H1. A connection point P1 formed at the tip of the ground electrode 3 is connected to the electric wire 2. The connection point P1 is subjected to grounding work to the ground H1. The connection point P1 is connected to a ground point of the ground H1 by an electric wire such as a stranded wire. The ground resistance is indicated by a symbol R3 shown in FIG. 3, and is preferably approximately 10[Ω], but the value is not limited. The connection point P1 is connected to the voltage control device 4 provided on the ground.

The ground electrode 3 may be mounted on a moving object capable of moving on the ground. By moving the moving object on which the ground electrode 3 is mounted, the ground electrode 3 can be appropriately moved to a place where the thundercloud 50 is generated or a place where it is predicted that a thundercloud is to be generated.

In the equivalent circuit shown in FIG. 3, the voltage (potential) generated by the electric charge accumulated in the thundercloud 50 is indicated by V2, and the resistance of air existing between the thundercloud 50 and the discharge electrode 11 is indicated by R1. The resistance of the electric wire 2 is indicated by R2, and the ground resistance of the ground electrode 3 is indicated by R3.

As shown in FIG. 3, a polarity switching circuit 5 is provided in an electric wire connecting the connection point P1 and a ground point.

The polarity switching circuit 5 is mounted with two diodes D1, D2 arranged in parallel with each other and having opposite polarities, and a changeover switch S2 for selecting one of the diodes D1, D2. The changeover switch S2 is switched by, for example, a user, according to the direction of the current flowing by the lightning discharge.

The polarity of the electric charge accumulated in the thundercloud 50 is discriminated, and the changeover switch S2 can be automatically switched. For example, it is known that positive charges are accumulated in the thundercloud 50 generated in winter and negative charges are accumulated in the thundercloud 50 generated in other seasons. Accordingly, the changeover switch S2 may be automatically changed over according to the season.

Further, the polarity of the electric charge accumulated in the thundercloud 50 can be discriminated by using a device for measuring an electric field in the atmosphere such as a field mill, and the changeover switch S2 can be automatically switched on the basis of the result of the discrimination.

The polarity switching circuit 5 may be a lightning arrester, for example, in addition to a circuit composed of the diodes D1, D2 and the changeover switch S2. The polarity switching circuit 5 holds a potential at the connection point P1 when a voltage is output from a pulse power supply 41, and is used for setting a path of a current flowing by a lightning discharge.

The voltage control device 4 includes the pulse power supply 41 (power supply unit), a trigger switch S1, and a protection switch F1. The voltage control device 4 controls a voltage generated in the discharge electrode 11 (conductor).

The trigger switch S1 is a switch operated by the user when a voltage is supplied to the discharge electrode 11 mounted on the flying object 1.

The pulse power supply 41 outputs a pulse voltage when the trigger switch S1 is turned on. The pulse power supply 41 can be constituted by, for example, a DC power supply (not shown) and a capacitor (not shown). The pulse power supply 41 accumulates the voltage output from the DC power supply in the capacitor, and outputs a pulse voltage when the user turns on the trigger switch S1. The pulse voltage output from the pulse power supply 41 is supplied to the discharge electrode 11 mounted on the flying object 1 via the connection point P1 of the ground electrode 3 and the electric wire 2.

The protection switch F1 is, for example, a fuse, and when an overcurrent flows in the voltage control device 4, the circuit is cut off to protect the entire device from the overcurrent.

An operation of the lightning discharge induction system according to the present embodiment configured as described above will be described next. When the thundercloud 50 is generated in the sky or when the generation of the thundercloud 50 is predicted, the user flies the flying object 1 in the sky and brings the flying object 1 close to the lower part of the thundercloud 50, as shown in FIG. 2. As described above, since the flight position and flight altitude of the flying object 1 flying unmanned can be adjusted by autopilot or remote control, the flying object 1 can be brought close to the lower part of the thundercloud 50. At this moment, the changeover switch S2 of the polarity switching circuit 5 is connected to the diode D1.

When the flying object 1 approaches the lower part of the thundercloud 50, a voltage is generated between the thundercloud 50 and the discharge electrode 11. That is, a voltage is generated by the negative charge accumulated in the thundercloud 50 and the positive charge induced in the discharge electrode 11. Air is present between the thundercloud 50 and the discharge electrode 11 at this time. In FIG. 3, the resistance due to air is indicated by the symbol R1.

At this point of time, when a dielectric breakdown occurs between the thundercloud 50 and the discharge electrode 11, a lightning discharge occurs between the thundercloud 50 and the discharge electrode 11, and a current I1 (hereinafter referred to as “discharge current I1”) by the lightning discharge flows through the electric wire 2 (resistance R2). As described above, the ground electrode 3 is grounded to the ground H1 by the ground resistance R3, and the discharge current I1 flows from the ground H1 to the thundercloud 50. That is, discharge can be intentionally generated between the thundercloud 50 and the ground H1.

In the present embodiment, considering the case where a dielectric breakdown does not occur even if the flying object 1 is brought close to the thundercloud 50, the user turns on the trigger switch S1 and supplies the pulse voltage output from the pulse power supply 41 to the discharge electrode 11. Since the pulse voltage generated by the pulse power supply 41 is supplied to the discharge electrode 11 via the electric wire 2, the voltage generated between the discharge electrode 11 and the thundercloud 50 rises.

Therefore, a dielectric breakdown occurs between the thundercloud 50 and the discharge electrode 11. That is, a lightning discharge is induced between the thundercloud 50 and the discharge electrode 11, a discharge current flows from the ground H1 to the electric wire 2 via the ground electrode 3, and this discharge current flows to the thundercloud 50. Thus, discharge can be intentionally generated between the thundercloud 50 and the ground H1, and the occurrence of a lightning strike to an unspecified place can be prevented.

Thus, the lightning discharge induction system according to the present embodiment includes the flying object 1 flying in the air, the discharge electrode 11 provided to the flying object 1, the ground electrode 3 provided on the ground, the electric wire 2 for connecting the discharge electrode 11 and the ground electrode 3, and the voltage control device 4 for controlling a voltage generated in the discharge electrode 11.

In the present embodiment, the flying object 1 is caused toward the lower part of the thundercloud 50, and the pulse voltage output from the pulse power supply 41 is supplied to the discharge electrode 11 to intentionally cause a dielectric breakdown.

Therefore, a lightning discharge can be induced at timing intended by the user without being affected by the amount of electric charges accumulated in the thundercloud 50, the speed at which the electric charges are accumulated, and the state of the atmosphere.

In the present embodiment, since the lightning discharge can be induced at the timing intended by the user, the lightning discharge can be generated in a short time, and the labor of the user can be reduced. In the present embodiment, since the lightning discharge can be induced without flying the flying object 1 for a long time, the battery consumption of the flying object 1 can be reduced.

In the present embodiment, since the pulse voltage is supplied to the discharge electrode 11 to generate a lightning discharge, a lightning discharge can be induced without bringing the flying object 1 close to the thundercloud 50 more than necessary. Therefore, the electric wire 2 for connecting the flying object 1 and the ground electrode 3 can be shortened.

In the present embodiment, a lightning discharge can be generated without fine adjustment of the flight position and flight altitude of the flying object 1. Therefore, the payload of the flying object 1 can be reduced.

In the present embodiment, since the pulse voltage is supplied to the discharge electrode 11 to adjust the voltage generated in the discharge electrode 11, a lightning discharge can be forcibly induced at the time before the electric charge accumulated in the thundercloud 50 increases to the extent the lightning strikes cause damage, that is, at the time when the voltage is low. Therefore, the impact and damage inflicted on the flying object 1 by the discharge can be mitigated.

In the present embodiment, even in the event of a thundercloud that does not normally cause a lightning strike, the electric charge stored in this thundercloud can be discharged, reducing the risk of damage from lightning strikes to ground facilities.

### Explanation of First Modification

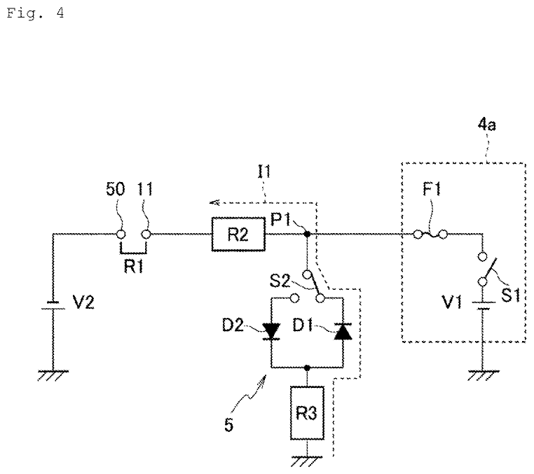

Next, a first modification of the foregoing embodiment will be described with reference to the equivalent circuit shown in FIG. 4. As shown in FIG. 4, a voltage control device 4a provided in a lightning discharge induction system according to the first modification includes a DC power supply V1 (power supply unit). In the first modification, the trigger switch S1 is turned on, thereby supplying a DC voltage output from the DC power supply V1 to the discharge electrode 11 mounted on the flying object 1.

In such a configuration, as in the foregoing embodiment, it is possible to cause a dielectric breakdown between the thundercloud 50 and the discharge electrode 11 at the timing intended by the user, thereby inducing a lightning discharge. Further, in the first modification, since it is not necessary to provide the pulse power supply 41 for generating a pulse voltage, the circuit configuration can be simplified and the cost can be reduced.

### Explanation of Second Modification

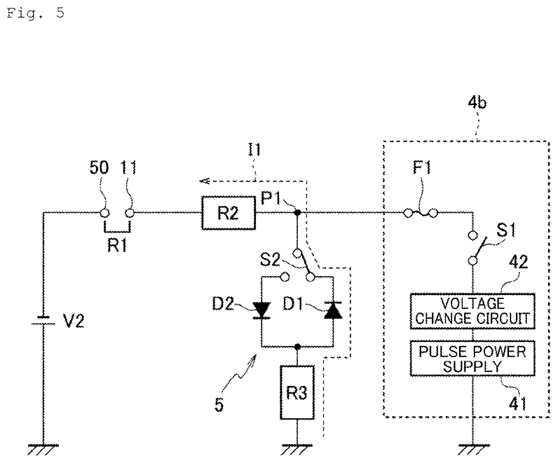

Next, a second modification of the foregoing embodiment will be described with reference to the equivalent circuit shown in FIG. 5. As shown in FIG. 5, a voltage control device 4b provided in a lightning discharge induction system according to the second modification differs from the voltage control device 4 shown in FIG. 3 in having a voltage change circuit 42 (voltage change unit).

The voltage change circuit 42 is provided with, for example, a plurality of capacitors, and is set so that a voltage connecting the respective capacitors in series is output when the trigger switch S1 is turned on. Thus, the voltage output from the pulse power supply 41 can be changed and supplied to the discharge electrode 11 mounted on the flying object 1.

In the second modification, for example, if a dielectric breakdown does not occur between the thundercloud 50 and the discharge electrode 11 even if the pulse voltage output from the pulse power supply 41 is supplied to the discharge electrode 11, the voltage value of the pulse voltage is changed by the voltage change circuit 42. For example, the amplitude of the pulse voltage is set to double. As a result, the voltage generated in the discharge electrode 11 can be made higher, and the occurrence of a dielectric breakdown can be promoted to induce a lightning discharge. That is, by gradually increasing the voltage output from the pulse power supply 41 to the discharge electrode 11, the lightning discharge can be surely generated at the timing intended by the user.

The foregoing embodiments and the first and second modifications have described an example in which the electric charges accumulated in the thundercloud 50 are negative electric charges and the electric charge generated in the discharge electrode 11 is a positive electric charge. However, when the electric charges accumulated in the thundercloud 50 are positive electric charges, the electric charge generated in the discharge electrode 11 may be a negative electric charge. That is, the polarity of the voltage output from the voltage control devices 4, 4a and 4b shown in FIGS. 3, 4 and 5 may be changed. Also, the changeover switch S2 of the polarity switching circuit 5 is switched to the diode D2 side.

For example, it is known that positive charges are accumulated in the thundercloud 50 generated in winter and negative charges are accumulated in the thundercloud 50 generated in other seasons. Thus, by changing the polarity of the voltage output from the voltage control device 4 according to the season, a lightning discharge can be surely induced.

The foregoing embodiments and the first and second modifications have described an example in which the ground electrode 3 is fixed on the ground. However, the ground electrode 3 can be moved to any place by mounting the ground electrode 3 on a moving body such as a vehicle. With such a configuration, the ground electrode 3 can be appropriately moved to an area where the thundercloud 50 occurs, preventing damage caused by a lightning strike.

The present invention is not limited to the foregoing embodiments, and numerous modifications can be made within the scope and gist of the present invention.

### REFERENCE SIGNS LIST

1 Flying object
2 Electric wire
3 Ground electrode
4, 4a, 4b Voltage control device
5 Polarity switching circuit
11 Discharge electrode (conductor)
12 Propeller
41 Pulse power supply (power supply unit)
42 Voltage change circuit (voltage changing unit)
50 Thundercloud
S1 Trigger switch
S2 Changeover switch
V1 DC power supply (power supply unit)

1. A lightning discharge induction system, comprising:
a flying object flying in the air;
a conductor provided to the flying object;
a ground electrode provided on the ground;
an electric wire configured to connect the conductor and the ground electrode; and
a voltage controller configured to control a voltage generated in the conductor.

2. The lightning discharge induction system according to claim 1,
wherein the voltage controller includes:
a power supply configured to output a DC voltage; and
a trigger switch configured to output the DC voltage to the conductor.

3. The lightning discharge induction system according to claim 2, wherein the power supply is a pulse power supply configured to output a pulse voltage.

4. The lightning discharge induction system according to claim 3,
wherein the voltage controller includes:
a voltage changing circuit configured to change a voltage value of the pulse voltage.

5. A lightning discharge induction flying object that flies in the air to induce a lightning discharge, the lightning discharge induction flying object comprising:
a conductor; and
an electric wire configured to connect for connecting the conductor and a ground electrode provided on the ground.

6. A voltage control device that generates a voltage for inducing a lightning discharge in a conductor provided to a flying object, the voltage control device comprising:
a power supply configured to generate a pulse voltage; and
a trigger switch configured to output the pulse voltage to an electric wire connecting the conductor and a ground electrode provided on the ground.
